(19) United States
(12) Patent Application Publication
(10) Pub. No.: US 2010/0094822 A1
(43) Pub. Date: Apr. 15, 2010

(54) System and method for determining a file save location

(76) Inventor: Rohit Dilip Kelapure, Morrisville, NC (US)

Correspondence Address: HOLMAN IP LAW/IBM RSW, 175 S Main Street, Suite #850, Salt Lake City, UT, 84111, US

(21) Appl. No.: 12/250,255

(22) Filed: Oct. 13, 2008

(51) Int. Cl. G06F 17/30; G06F 12/02; G06N 7/02

(52) U.S. Cl. 707/705; 706/52; 707/E17.01; 707/E17.015; 707/E17.017

(57) ABSTRACT

A system to suggest a directory location in which to save a file. The system includes a client computer and a folder storage locator. The client computer initiates a file save operation. The folder storage locator communicates the suggestion of the directory location in which to save the file. The folder storage locator includes a context identifier, a context analyzer, and a location trigger. The context identifier identifies contextual information of a file in response to a save operation to save the file on a storage device. The context analyzer compares the contextual information of the file to indexing data of an indexing service. The indexing data indexes existing files on the storage device. The location trigger communicates a potential file storage location on the storage device based on the comparison of the contextual information of the file to the indexing data of the indexing service.

### BACKGROUND

Command line interface (CLI) and graphical user interface (GUI) based operating systems typically include a file system. A file system is a software and/or hardware based mechanism for storing and organizing computer files and the data they contain for easy and quick access and retrieval. A file system usually includes one or more folders in which files and other similar data are stored. Currently, a user may save a certain file to a storage device such as a hard disk or flash drive through the file system interface of CLI and/or GUI based operating systems.

Typically the user specifies an existing folder of the file system in which to save the certain file when the user requests for an application such as a browser, a word processor, or any other similar application to save or persist the file on to a storage device. If the user does not store the file to an existing folder, the user may also create a new folder in which to save the certain file. Additionally, the operating system may assume a default folder in which to save the file based on earlier preferences and present the default folder location to the user. Unfortunately, when an operating systems does suggest a default folder the folder location is typically the same default folder location for every save request regardless of the file type and/or the application.

### SUMMARY

Embodiments of a system are described. In one embodiment, the system is a computing system to suggest to a user a directory location in which to save a file. An embodiment of the system includes a client computer and a folder storage locator. The client computer initiates a file save operation. The folder storage locator in general is configured to communicate the suggestion of the directory location in which to save the file associated with the file save operation. Some embodiments of the folder storage locator include a context identifier, a context analyzer, and a location trigger. The context identifier is configured to identify contextual information of a file in response to a save operation to save the file on a storage device. The context analyzer is configured to compare the contextual information of the file to indexing data of an indexing service. The indexing data indexes existing files on the storage device. The location trigger is configured to communicate a potential file storage location on the storage device based on the comparison of the contextual information of the file to the indexing data of the indexing service. Other embodiments of the system are also described.

Embodiments of a method are also described. In one embodiment, the method is a method for suggesting to a user a directory location in which to save a file. An embodiment of the method includes identifying contextual information of a file in response to a save operation to save the file on a storage device, comparing the contextual information of the file to indexing data of an indexing service, and communicating a potential file storage location on the storage device based on the comparison of the contextual information of the file to the indexing data of the indexing service. The indexing data indexes existing files on the storage device. Other embodiments of the method are also described.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 depicts a schematic block diagram of one embodiment of a computer network system.

FIG. 2 depicts a schematic block diagram of one embodiment of the memory device of the client computer depicted in the computer network system of FIG. 1.

FIG. 3 depicts a schematic block diagram of one embodiment of the file system of FIG. 2.

FIG. 4 depicts a schematic diagram of one embodiment of the file storage locator of FIG. 1.

FIG. 5 depicts a schematic diagram of one embodiment of entries in the rule database of FIG. 2.

FIG. 6 depicts a schematic flow chart diagram of one embodiment of a method for suggesting a file save location.

FIG. 7 depicts a schematic flow chart diagram of one embodiment of the operation for analyzing a file property in conjunction with the method of FIG. 6.

FIG. 8 depicts a schematic flow chart diagram of one embodiment of a method for creating a new rule based on an analysis of an existing folder of a file system.

Throughout the description, similar reference numbers may be used to identify similar elements.

### DETAILED DESCRIPTION

In the following description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

While many embodiments are described herein, at least some of the described embodiments facilitate the selection of a folder in which to save a file associated with a file save operation by a user of a computer operating system. When a user-agent such as a web browser or an application such as a word processor prompts the user with a location in which to save a file, the user-agent or the application references an indexing service associated with the operating system. The user-agent or application determines the location in which to save the file automatically according to contextual information associated with the file and/or indexing data associated with the indexing service.

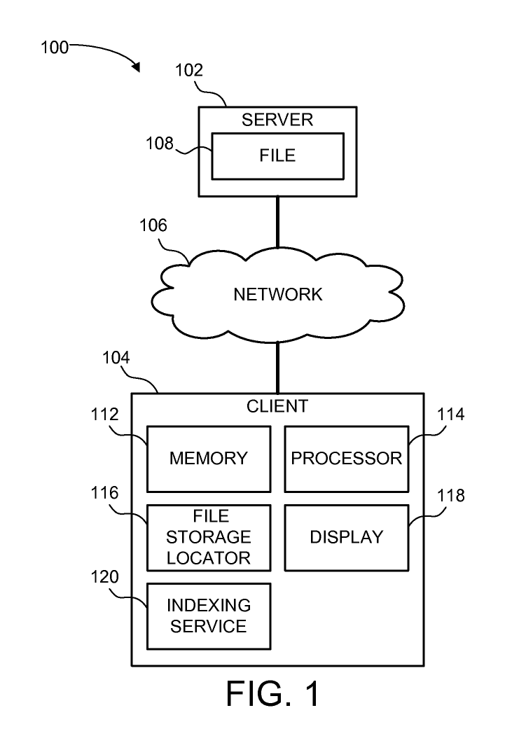

FIG. 1 depicts a schematic block diagram of one embodiment of a computer system 100. As depicted, the computer system 100 includes a server 102, a network 106, and a client computer 104. Additionally, the server includes a file 108. Additionally, the client computer 104 includes a memory device 112, a processor 114, a file storage locator 116, a display 118, and an indexing service 120. The computer system 100 may interface a system user with the server 102 according to the interface operations of the client computer 104. Although the depicted computer system 100 is shown and described herein with certain components and functionality, other embodiments of the computer system 100 may be implemented with fewer or more components or with less or more functionality. For example, some embodiments of the computer system 100 do not include a network and a server. Hence, some embodiments of the computer system 100 include only the client computer 104 and the file 108 is generated and stored only on the client computer 104. Additionally, some embodiments of the computer system 100 may include a plurality of servers 102 and a plurality of networks 106. Additionally, some embodiments of the computer system 100 may include similar components arranged in another manner to provide similar functionality, in one or more aspects.

As depicted, the server 102 hosts an application that the system user may access through the client computer 104. By interfacing with the server 102, the user may generate a file 108 associated with the application. Although the computer system 100 depicts the file on the server 102, in some embodiments, the file generated by the system user is generated on the client computer 104. Alternatively, in some embodiments, the application associated with the file runs on the client computer 104 in conjunction with the memory device 112 and the processor 114 of the client computer 104. In one embodiment, the server 102 is an array of servers. Additionally, multiple server instances may be run on a single server 102.

The client computer 104 manages an interface between the system user and the server 102. In one embodiment, the client computer 104 is a desktop, or laptop computer. In other embodiments, the client computer 104 is a mobile computing device that allows a user to connect to and interact with an application running on the server 102 associated with the file 108. The client computer 104 connects to the server 102 via a local area network (LAN) or other similar network 106.

As explained above, in some embodiments, the system user generates the file 108 on the client computer 104 in conjunction with the memory device 112 and the processor 114. In some embodiments, the memory device 112 is a random access memory (RAM) or another type of dynamic storage device. In other embodiments, the memory device 112 is a read-only memory (ROM) or another type of static storage device. In other embodiments, the illustrated memory device 112 is representative of both RAM and static storage memory within the computer system 100. Hence, the memory device 112 may store operations and functions associated with the generation of the file as well as a save operation to save the file to the memory device 112. In other embodiments, the memory device 112 is an electronically programmable read-only memory (EPROM) or another type of storage device. Additionally, some embodiments store the instructions as firmware such as embedded foundation code, basic input/output system (BIOS) code, or other similar code.

In one embodiment, the processor 114 is a central processing unit (CPU) with one or more processing cores. In other embodiments, the processor 114 is a graphical processing unit (GPU) or another type of processing device such as a general purpose processor, an application specific processor, a multi-core processor, or a microprocessor. Alternatively, a separate GPU may be coupled to the display device 118. In general, the processor 114 executes one or more instructions to provide operational functionality to the computer system 100. The instructions may be stored locally in the processor 114 and/or in the memory device 112. Alternatively, the instructions may be distributed across one or more devices such as the processor 114, the memory device 112, or another data storage device.

In one embodiment, the file storage locator 116 prompts the user with a location in which to save the file. The file storage locator 116 references an indexing service 120 associated with the operating system of the client computer 104. The file storage locator 116 determines the location in which to save the file automatically according to contextual information associated with the file and/or indexing data associated with the indexing service 120.

In some embodiments, the display device 118 is a graphical display such as a cathode ray tube (CRT) monitor, a liquid crystal display (LCD) monitor, or another type of display device. In one embodiment, the display device 118 is configured to visually communicate a potential file storage location on the memory device 112 based on a comparison of the contextual information of the file to the indexing data of the indexing service 120.

In one embodiment, the indexing service 120 is configured to extract content from files stored on the client computer 104 and to construct an index to facilitate the search of one or more of the files. Additionally, in some embodiments, the indexing service 120 may extract both text and property information from files on the client computer 104 as well as remote files on networked hosts such as the server 102. The files can be simply members of a selected file system or part of a virtual web hosted by, for example, Internet Information Services™ (IIS). The indexing service 120 then stores the index on the memory device 112.

The network 106 may communicate traditional block input/output (I/O), such as over a storage area network (SAN). The network 106 may also communicate file I/O, such as over a transmission control protocol/internet protocol (TCP/IP) network or similar communication protocol. In some embodiments, the computer system 100 comprises two or more networks 106. Alternatively, the client computer 104 may be connected directly to a server 102 via a backplane or system bus. In one embodiment, the network 106 may include a cellular network, other similar type of network, or combination thereof.

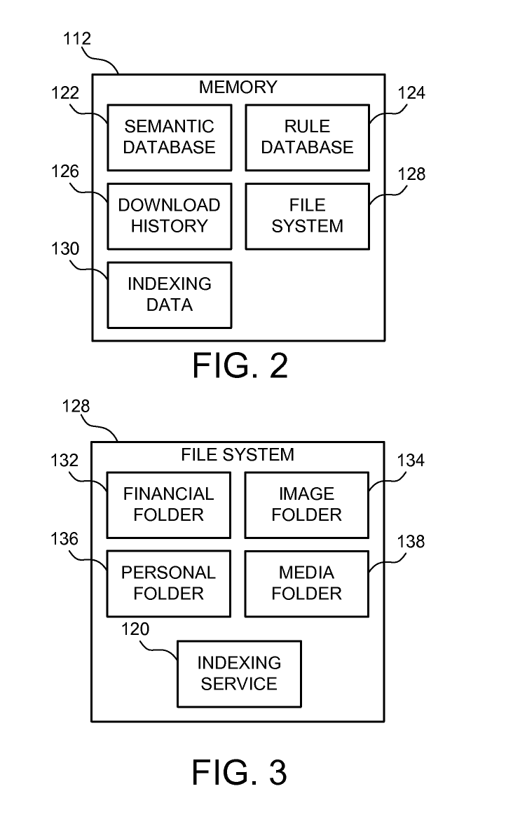

FIG. 2 depicts a schematic block diagram of one embodiment of the memory device 112 of the client computer 102 depicted in the computer system 100 of FIG. 1. As depicted, the memory device 112 includes a semantic database 122, a rule database 124, a download history 126, a file system 128, and indexing data 130. Although the memory device 112 is depicted as being associated with the client computer 104, in some embodiments, the memory device 112 and components thereof are associated with the client computer 104 and/or the server 102.

In one embodiment, the semantic database 122 is configured to store an entry that contains a meaning of at least one word in a set of one or more words. In some embodiments, the semantic database 122 contains associations between various text strings and the semantic elements of those various text strings. For example, the semantic database 122 may include an entry that associates the term “401k” with a general meaning of “finances.” Alternatively, in some embodiments, the semantic database 122 contains direct associations between various text strings and a property of a file such as a file name or metadata associated with the file to be saved.

In one embodiment, the rule database 124 is configured to store an association between indexing data of the indexing service and a property of a file associated with a file save operation. Additionally, the rule database may include associations between a property of a stored file that is already stored on the client computer 104 and the indexing data of the indexing service. For example, the rule database 124 may include an association between a file name that includes the term “finance” with a folder named “finances.”

In one embodiment, the download history 126 includes a file storage location of at least one previous save operation of a stored file. In other words, the system user may save a file that includes the term “finance” in the file name in the folder named “finances.” Thus, the download history 126 includes the name of the file and the location where the file is saved on the client computer 104. Additionally, the download history 126 may include other file properties such as a name of the application used by the system user to generate the file, data and contextual information of the data in the file, a unified resource locator (URL) associated with the file, metadata associated with the file, metadata associated with the folder in which the file is stored, and other similar file properties.

In one embodiment, the file system 128 is a software and/or hardware mechanism to store and organize electronic content such as files and data stored in the files on a storage device such as the memory device 112. The file system 128 generally allows a system user to find, search for, and access the files stored on the storage device. Hence, in general, the file system 128 is a database for the storage, hierarchical organization, manipulation, navigation, access, and retrieval of files and data associated with the files. The file system may include a disk file system, a flash file system, a database file system, a transactional file system, a network file system, and other similar file systems. The file system 128 may include a data storage device such as a hard disk or compact disk read only memory (CD-ROM) and involve the maintenance of the physical locations of the files. Additionally, the file system 128 may include access to data on a file server such as the server 102 of FIG. 1 by acting as a client for a network protocol. Additionally, the file system 128 may include a virtual filing system such as a process file system (procfs).

As explained above, the indexing service 120 extracts content from files stored on the client computer 104 to construct an index such as the indexing data 130 stored on the memory device 112. The indexing data 130 is configured to facilitate the search of one or more files stored on the client computer 104 in conjunction with the file system 128. The indexing service 120 then stores the indexing data 130 on the memory device 112 as depicted in FIG. 2.

FIG. 3 depicts a schematic block diagram of one embodiment of the file system 128 of FIG. 2. As illustrated in FIG. 3, the file system includes a number of folders such as a financial folder 132, an image folder 134, a personal folder 136, and a media folder 138. Although FIG. 3 depicts the file system 128 with four distinct folders, the file system 128 may include less or more folders. In a further embodiment, the file system includes an indexing service 120. Although FIG. 3 depicts the indexing service 120 in conjunction with the file system 128 and indirectly with the client computer 104 of FIG. 1, the indexing service 120 may reside, at least in part, on the server 102 of FIG. 1.

As explained above, the file system may include less or more than the four depicted folders 132, 134, 136, and 138. A system user may create other types of folders such as a document folder, a music folder, and so on. The four folders of FIG. 3 represent four possible folders that the system user may create within the file system 128 of the client computer 104. In other words, the system user may store any file related to financial matters in the financial folder 132. Likewise, the user may store any file related to images and digital photographs in the image folder 134, and so on. The depicted folders 132, 134, 136, and 138 may include metadata related specifically to each folder. For example, metadata of the image folder 134 may include the name of the image folder 134, data types stored in the image folder such as bitmap (.bmp) and joint photographic experts group (.jpg), names of files stored in image folder 134, and so on.

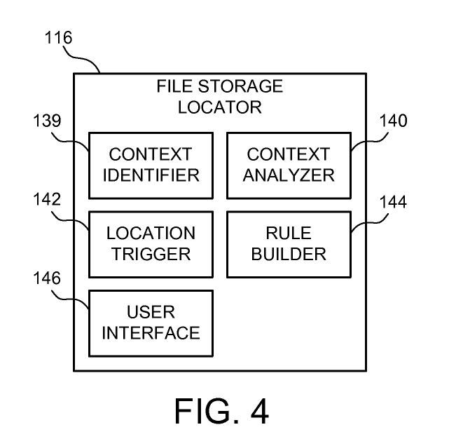

FIG. 4 depicts a schematic diagram of one embodiment of a file storage locator 116 of the client computer of the computer network system of FIG. 1. As depicted in FIG. 4, the file storage locator 116 includes a context identifier 139, a context analyzer 140, a location trigger 142, a rule builder 144, and a user interface 146.

In one embodiment, the context identifier 139 is configured to identify contextual information of a file in response to a save operation to save the file on a storage device of the client computer 104 such as the memory device 112. In some embodiments, the context identifier 139 is configured to read a property of the file associated with the save operation. The file property may include a hypertext markup language (HTML) meta tag, a website uniform resource locator (URL), a file name, a file type, metadata associated with the file, and data content in the file.

The context analyzer 140 is configured to compare the contextual information of the file to the indexing data 130 generated by the indexing service 120. As explained above, the indexing data 130 includes an index of existing files on the storage device of the client computer 104. In some embodiments, the context analyzer 140 is configured to compare a file property of the file to at least one keyword associated with a rule stored in the rule database 124 and to determine whether a match exists between the file property and the at least one keyword. Additionally, the context analyzer 140 is configured to send a keyword match signal to the location trigger 142 to trigger the communication of at least one potential file storage location in which to save the file in response to the determination that the match exists between the file property and the at least one keyword. As explained above, the rule is configured to associate at least one keyword with at least one potential file storage location.

In some embodiments, the context analyzer is configured to compare a file property of the file to at least one entry of the semantic database 122 and to determine whether a semantic meaning of the file property exists in the semantic database 122 according to the comparison of the at least one entry of the semantic database to the file property. Additionally, the context analyzer 140 is configured to send a semantic match signal to the location trigger 142 to trigger the communication of at least one potential file storage location in which to save the file in response to the determination that the semantic meaning of the file property exists in the semantic database 122.

In some embodiments, the context analyzer 140 is configured to perform a fuzzy match operation. Hence, the context analyzer 140 may be configured to compare a file property of the file to at least one keyword associated with the rule and to determine whether an approximate match exists between the file property and the at least one keyword. Additionally, the context analyzer 140 is configured to send a keyword match signal to the location trigger 142 to trigger the communication of at least one potential file storage location in which to save the file in response to the determination that the approximate match exists between the file property and the at least one keyword.

In one embodiment, the location trigger 142 is configured to communicate a potential file storage location on the storage device based on the comparison of the contextual information of the file to the indexing data 130 of the indexing service 120. As explained above, in some embodiments, the display device 118 is configured to display the communication of the potential file storage location on the storage device to the user of the client computer 104.

In one embodiment, the rule builder 144 is configured to notify a user to choose a directory in which to save the file in response to the determination that no match exists between the file property and the at least one keyword. The rule builder 144 is configured to analyze the file save selection of the user and to create a new rule based on the file save selection of the user. The rule builder 144 then stores the new rule in the rule database 124. In some embodiments, the context identifier 139 is configured to read the download history 126 stored in the memory device 112. As explained above, the download history 126 includes a file storage location of at least one previous save operation of a stored file. The context identifier 139 in conjunction with the rule builder 144 is configured to create a new rule based on the properties of the previous save operation in the download history 126. The new rule includes an association between the file storage location and a property of the stored file. The context identifier 139 in conjunction with the rule builder 144 is configured to save the new rule in the rule database 124.

In one embodiment, the user interface 146 is configured to allow a user to create a new rule and to save the new rule in the rule database 124. Additionally, the user interface 146 is configured to allow a user to modify an existing rule previously stored in the rule database 124 and to save the modified rule in the rule database 124.

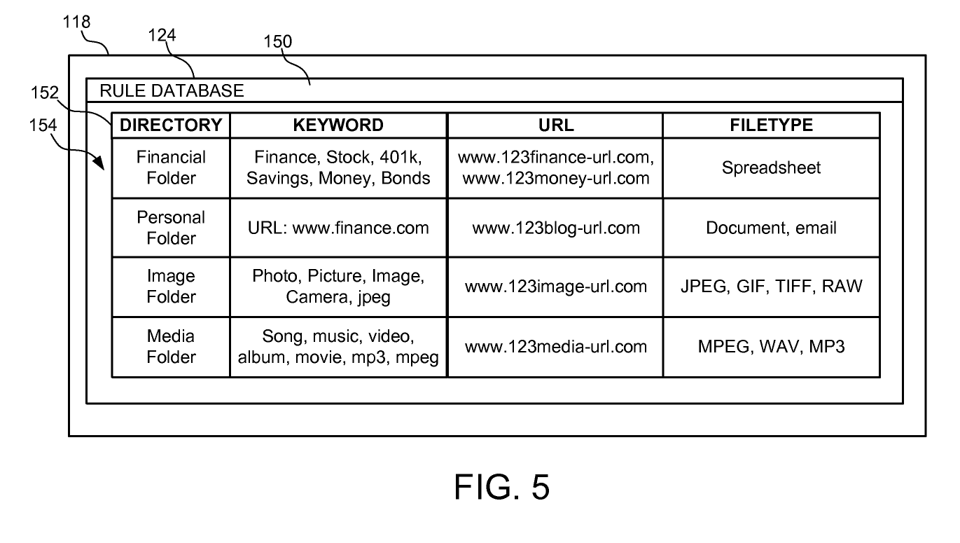

FIG. 5 depicts a schematic diagram of one embodiment of entries in the rule database 124 of FIG. 2. In particular, FIG. 5 depicts the keyword associations stored in the rule database 124 displayed on the display device 118. In some embodiments, the keyword associations stored in the rule database 124 are substantially similar in format to the entries stored in the semantic database 122. It should be noted that other embodiments of the rule database 124 may be integrated with fewer or more fields in relation to a stored association.

The illustrated keyword associations includes a title bar 150, a header row 152, and data rows 154. The title bar 150 depicts a title of the keyword associations. The header row 152 includes a directory column that shows the folders of the file system 128 such as the financial folder 132, a keyword column that shows certain keywords associated with a folder of the file system 128, a URL column that associates certain URLs with a folder of the file system 128, and a file-type column that associates certain types of files with a folder of the file system 128. In other words, the first data row associates the financial folder 132 with the keywords finance, stock, 401k, savings, money, bonds, and so forth. Additionally, the first data row associates the financial folder 132 with the example URLs 123finance-url.com and 123money-url.com. Additionally, the first data row associates the financial folder 132 with spreadsheet types of files. Likewise, as depicted, the other data rows associate the other folders 134, 136, and 138 with specific keywords, URLs, and file-types. In some embodiments, the header row 152 includes fewer or more columns. As depicted, the data rows 154 include four data rows for the four folders 132, 134, 136, and 138 of the file system 128. In some embodiments, the data rows 154 include fewer or more data rows.

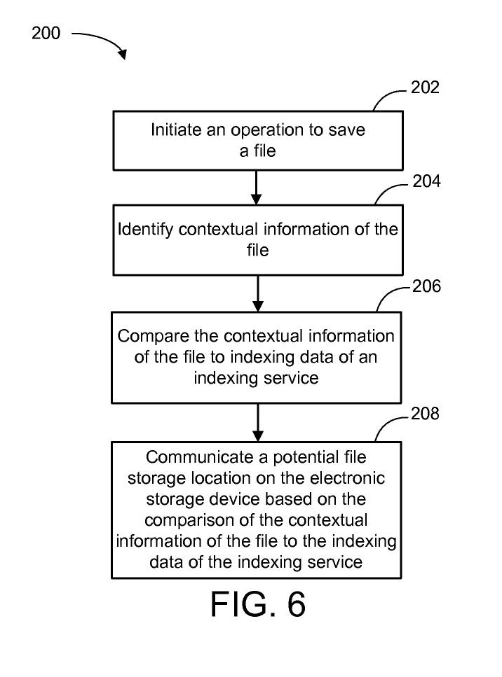

FIG. 6 depicts a schematic flow chart diagram of one embodiment of a method 200 for suggesting a file save location. For ease of explanation, the method 200 is described with reference to the file storage locator 116 of FIG. 4. However, some embodiments of the method 200 may be implemented with other file storage locators.

In the illustrated method 200 of FIG. 6 a user of the client computer 104 initiates 202 an operation to save a file. As explained above, the file may be generated and/or stored on the server 102 such as a web server. In an alternate embodiment, the file may be generated and/or stored on the client computer 104. The context identifier 139 identifies 204 contextual information associated with the file. For example, as explained above, the context identifier 139 may identify such contextual information as a file type, a file name, metadata of the file, and so forth. The context analyzer 140 then compares 206 the contextual information of the file to indexing data 130 generated by the indexing service 120. The location trigger 142 then communicates a potential file storage location on the storage device based on the comparison of the contextual information of the file to the indexing data 130 of the indexing service 120.

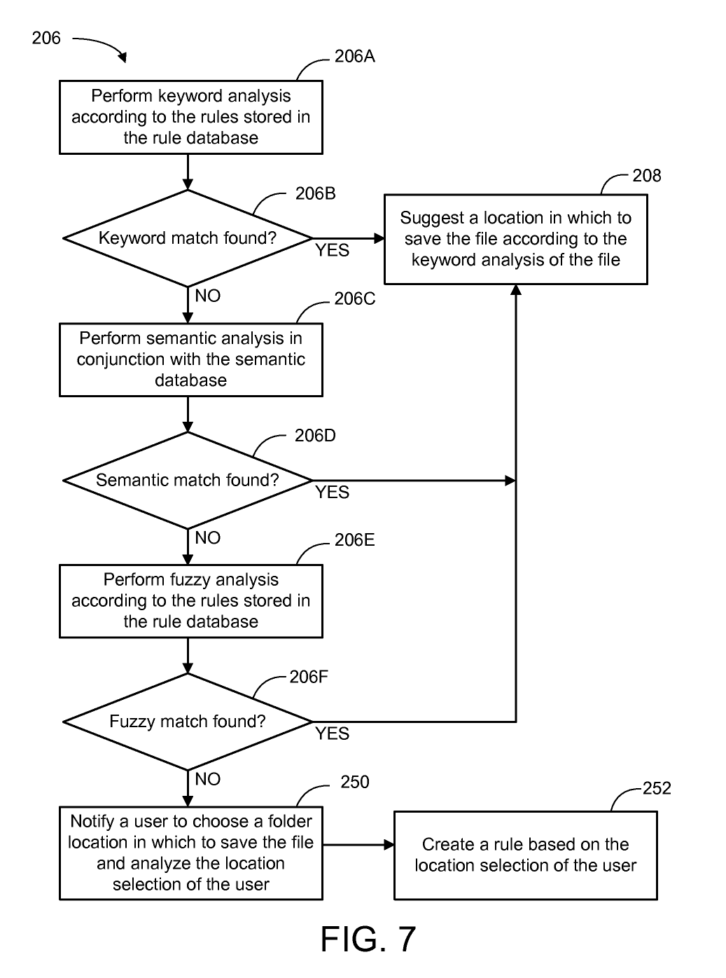

FIG. 7 depicts a schematic flow chart diagram of one embodiment of the compare 206 operation in conjunction with the method of FIG. 6. For ease of explanation, the operation is described with reference to the file storage locator 116 of FIG. 4. However, some embodiments of the compare 206 operation may be implemented with other file storage locators.

In the illustrated compare 206 operation of FIG. 7, the context analyzer 140 performs 206A keyword analysis according to the rules stored in the rule database 124 and illustrated in one embodiment of the rule database 124 in FIG. 5. The context analyzer 140 determines 206B whether a keyword match is found in the rule database 124. If the context analyzer 140 determines 206B that a keyword match is found then the location trigger 142 suggests 208 a location in which to save the file according to the keyword analysis of the file. Otherwise, the context analyzer 140 performs 206C semantic analysis in conjunction with the semantic database 122. The context analyzer 140 determines 206D whether a semantic match is found in the semantic database 122. If the context analyzer 140 determines 206C that a match is found in the semantic database 122 then the location trigger 142 suggests 208 a location in which to save the file according to the semantic analysis of the file. Otherwise, the context analyzer 140 performs 206E fuzzy analysis according to the rules stored in the rule database 124.

The context analyzer 140 determines 206F whether a fuzzy match is found in the rule database 124. A fuzzy match is based on a partial or approximate match between a keyword in the rule database 124 and a property of the file. If the context analyzer 140 determines 206F that a fuzzy match is found then the location trigger 142 suggests 208 a location in which to save the file according to the fuzzy analysis of the file. Otherwise, the context analyzer 140 notifies a user to choose 250 a folder location in which to save the file and analyzes a location selection of the user. The context analyzer 140 in conjunction with the rule builder 144 then creates a rule based on the location selection of the user. In other words, the context analyzer 140 in conjunction with the rule builder 144 creates a new rule that associates at least one property of the file with the folder location in which the file is stored.

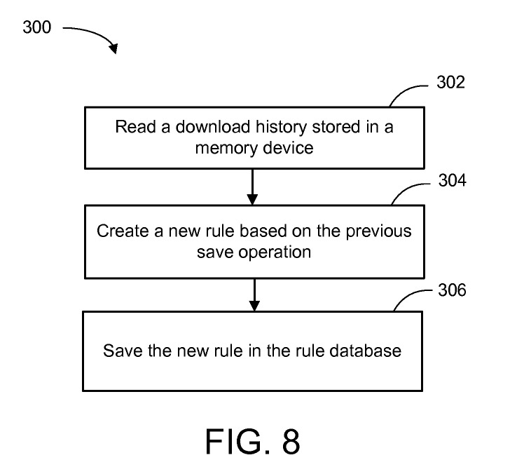

FIG. 8 depicts a schematic flow chart diagram of one embodiment of a method 300 for creating a new rule based on an analysis of an existing folder of a file system 128. For ease of explanation, the method 300 is described with reference to the file storage locator 116 of FIG. 4. However, some embodiments of the method 300 may be implemented with other file storage locators.

In the illustrated method 300 of FIG. 8 the context identifier is configured to read 302 a download history 126 stored in the memory device 112. In one embodiment, the context analyzer 140 in conjunction with the rule builder 144 creates 304 a new rule based on the previous save operation. The context analyzer 140 in conjunction with the rule builder 144 save 306 the new rule in the rule database 124.

It should also be noted that at least some of the operations of the methods 200 and 300 and the operation to compare 206 the contextual information of the file to indexing data 130 generated by the indexing service 120 may be implemented using software instructions stored on a computer useable storage medium for execution by a computer. As an example, an embodiment of a computer program product includes a computer useable storage medium to store a computer readable program that, when executed on a computer, causes the computer to perform operations, including an operation to identify contextual information of a file in response to a save operation to save the file on a storage device, an operation to compare the contextual information of the file to indexing data of an indexing service, wherein the indexing data indexes existing files on the storage device, and an operation to communicate a potential file storage location on the storage device based on the comparison of the contextual information of the file to the indexing data of the indexing service.

Embodiments of the invention can take the form of an entirely hardware embodiment, an entirely software embodiment, or an embodiment containing both hardware and software elements. In one embodiment, the invention is implemented in software, which includes but is not limited to firmware, resident software, microcode, etc.

Furthermore, embodiments of the invention can take the form of a computer program product accessible from a computer-usable or computer-readable storage medium providing program code for use by or in connection with a computer or any instruction execution system. For the purposes of this description, a computer-usable or computer readable storage medium can be any apparatus that can store the program for use by or in connection with the instruction execution system, apparatus, or device.

The computer-useable or computer-readable storage medium can be an electronic, magnetic, optical, electromagnetic, infrared, or semiconductor system (or apparatus or device), or a propagation medium. Examples of a computer-readable storage medium include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

An embodiment of a data processing system suitable for storing and/or executing program code includes at least one processor coupled directly or indirectly to memory elements through a system bus such as a data, address, and/or control bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Additionally, network adapters also may be coupled to the system to enable the data processing system to become coupled to other data processing systems or remote printers or storage devices through intervening private or public networks. Modems, cable modems, and Ethernet cards are just a few of the currently available types of network adapters.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A computer program product comprising a computer useable storage medium to store a computer readable program that, when executed on a computer, causes the computer to perform operations comprising:
identify contextual information of a file in response to a save operation to save the file on a storage device;
compare the contextual information of the file to indexing data of an indexing service, wherein the indexing data indexes existing files on the storage device; and
communicate a potential file storage location on the storage device based on the comparison of the contextual information of the file to the indexing data of the indexing service.

2. The computer program product of claim 1, wherein the computer readable program, when executed on the computer, causes the computer to perform file property analysis operations according to a keyword analysis based on a rule stored in a rule database, the operations comprising:
compare the contextual information of the file to at least one keyword associated with the rule, wherein the rule is configured to associate the at least one keyword with at least one of a plurality of potential file storage locations;
determine whether a match exists between the contextual information of the file and the at least one keyword; and
send a keyword match signal to a location trigger to trigger the communication of at least one of a plurality of potential file storage locations in which to save the file in response to the determination that the match exists between the contextual information of the file and the at least one keyword.

3. The computer program product of claim 1, wherein the computer readable program, when executed on the computer, causes the computer to perform file property analysis operations according to a semantic analysis based on a semantic database, the operations comprising:
compare the contextual information of the file to at least one entry of the semantic database;
determine whether a semantic meaning of the contextual information of the file exists in the semantic database according to the comparison of the at least one entry of the semantic database and the contextual information of the file; and
send a semantic match signal to a location trigger to trigger the communication of at least one of a plurality of potential file storage locations in which to save the file in response to the determination that the semantic meaning of the contextual information of the file exists in the semantic database.

4. The computer program product of claim 1, wherein the computer readable program, when executed on the computer, causes the computer to perform file property analysis operations according to a fuzzy analysis based on a rule stored in a rule database, the operations comprising:
compare the contextual information of the file to at least one keyword associated with the rule;
determine whether an approximate match exists between the contextual information of the file and the at least one keyword; and
send a keyword match signal to a location trigger to trigger the communication of at least one of a plurality of potential file storage locations in which to save the file in response to the determination that the approximate match exists between the contextual information of the file and the at least one keyword.

5. The computer program product of claim 1, wherein the computer readable program, when executed on the computer, causes the computer to perform learning operations, the operations comprising:
read a download history stored in a memory device, wherein the download history comprises a file storage location of at least one previous save operation of a stored file;
create a new rule based on the previous save operation, wherein the new rule comprises an association between the file storage location and a property of the stored file; and
save the new rule in a rule database.

6. The computer program product of claim 1, wherein the contextual information of the file comprises a hypertext markup language (HTML) meta tag, a website uniform resource locator (URL), a file name, a file type, metadata associated with the file, and content in the file.

7. An apparatus, comprising:
a context identifier to identify contextual information of a file in response to a save operation to save the file on a storage device;
a context analyzer to compare the contextual information of the file to indexing data of an indexing service, wherein the indexing data indexes existing files on the storage device; and
a location trigger to communicate a potential file storage location on the storage device based on the comparison of the contextual information of the file to the indexing data of the indexing service.

8. The apparatus of claim 7, wherein the context analyzer is further configured to:
compare the contextual information of the file to at least one keyword associated with a rule stored in a rule database;
determine whether a match exists between the contextual information of the file and the at least one keyword; and
send a keyword match signal to a location trigger to trigger the communication of at least one of a plurality of potential file storage locations in which to save the file in response to the determination that the match exists between the contextual information of the file and the at least one keyword, wherein the rule is configured to associate the at least one keyword with at least one of a plurality of potential file storage locations.

9. The apparatus of claim 8, the apparatus further comprising a user interface coupled to the rule database, the user interface to allow a user to:
create a new rule;
save the new rule in the rule database;
modify an existing rule; and
save the existing rule in the rule database.

10. The apparatus of claim 8, the apparatus further comprising a rule builder coupled to the context analyzer, the rule builder to:
notify a user to choose a directory in which to save the file in response to the determination that no match exists between the contextual information of the file and the at least one keyword;
analyze the file save selection of the user; and
create a new rule based on the file save selection of the user.

11. The apparatus of claim 8, wherein the context identifier is further configured to:
read a download history stored in a memory device, wherein the download history comprises a file storage location of at least one previous save operation of a stored file;
create a new rule based on the previous save operation, wherein the new rule comprises an association between the file storage location and the contextual information of the file of the stored file; and
save the new rule in the rule database.

12. The apparatus of claim 7, wherein the context analyzer is further configured to:
compare the contextual information of the file to at least one entry of a semantic database;
determine whether a semantic meaning of the contextual information of the file exists in the semantic database according to the comparison of the at least one entry of the semantic database to the contextual information of the file; and
send a semantic match signal to the location trigger to trigger the communication of at least one of a plurality of potential file storage locations in which to save the file in response to the determination that the semantic meaning of the contextual information of the file exists in the semantic database.

13. A system comprising:
a client computer to initiate a file save operation; and
a folder storage locator, the folder storage locator comprising:
a context identifier to identify contextual information of a file in response to a save operation to save the file on a storage device;
a context analyzer to compare the contextual information of the file to indexing data of an indexing service, wherein the indexing data indexes existing files on the storage device; and
a location trigger to communicate a potential file storage location on the storage device based on the comparison of the contextual information of the file to the indexing data of the indexing service.

14. The system of claim 13, wherein the context analyzer is further configured to:
compare the contextual information of the file to at least one keyword associated with a rule stored in a rule database;
determine whether a match exists between the contextual information of the file and the at least one keyword; and
send a keyword match signal to the location trigger to trigger the communication of at least one of a plurality of potential file storage locations in which to save the file in response to the determination that the match exists between the contextual information of the file and the at least one keyword, wherein the rule is configured to associate the at least one keyword with at least one of a plurality of potential file storage locations.

15. The system of claim 14, wherein the system further comprises a rule builder coupled to the context analyzer, the rule builder to:
notify a user to choose a directory in which to save the file in response to the determination that no match exists between the contextual information of the file and the at least one keyword;
analyze a file save selection of the user; and
create a new rule based on the file save selection of the user.

16. The system of claim 15, wherein the client computer comprises a memory device, the memory device comprising:
a file system comprising the plurality of potential file storage locations;
a semantic database coupled to the file system, the semantic database to store at least one entry, wherein the at least one entry defines a semantic meaning of at least one word of a set of words;
the rule database coupled to the file system, the rule database to store an association between the at least one keyword and the at least one of a plurality of potential file storage locations; and
a download history coupled to the file system, the download history comprising a file storage location of at least one previous save operation of a stored file.

17. The system of claim 13, wherein the client computer comprises a display device coupled to the location trigger, the display device to display the communication of the potential file storage location on the storage device.

18. A method comprising:
identifying contextual information of a file in response to a save operation to save the file on a storage device;
comparing the contextual information of the file to indexing data of an indexing service, wherein the indexing data indexes existing files on the storage device; and
communicating a potential file storage location on the storage device based on the comparison of the contextual information of the file to the indexing data of the indexing service.

19. The method of claim 18, further comprising:
comparing the contextual information of the file to at least one keyword associated with a rule stored in a rule database, wherein the rule is configured to associate the at least one keyword with at least one of a plurality of potential file storage locations;
determining whether a match exists between the contextual information of the file and the at least one keyword; and
sending a keyword match signal to a location trigger to trigger the communication of at least one of a plurality of potential file storage locations in which to save the file in response to the determination that the match exists between the contextual information of the file and the at least one keyword.

20. The method of claim 19, further comprising:
reading a download history stored in a memory device, wherein the download history comprises a file storage location of at least one previous save operation of a stored file;
creating a new rule based on the previous save operation, wherein the new rule comprises an association between the file storage location and a property of the stored file; and
saving the new rule in the rule database.
